(19) United States
(12) Patent Application Publication
(10) Pub. No.: US 2018/0272503 A1
(43) Pub. Date: Sep. 27, 2018

(54) SCREWDRIVER TIPPED PLIERS

(71) Applicants: William Matthew Sheridan, North Wales, PA (US); Jonathan Darwin Swartz, Collegeville, PA (US); Thomas Benjamin Ladner, North Wales, PA (US)

(72) Inventors: William Matthew Sheridan, North Wales, PA (US); Jonathan Darwin Swartz, Collegeville, PA (US); Thomas Benjamin Ladner, North Wales, PA (US)

(21) Appl. No.: 15/936,741

(22) Filed: Mar. 27, 2018

Related U.S. Application Data
(60) Provisional application No. 62/477,058, filed on Mar. 27, 2017.

(51) Int. Cl. B25B 7/22

(52) U.S. Cl. CPC B25B 7/22; B25B 15/005

(57) ABSTRACT

A multi-tool plier that includes a screwdriver bit that is integrally formed with a tip of the plier jaws. The multi-tool plier provides the user the mechanical advantages of applying a sufficient force to the bit and screw, improved torque, and on-axis operation of the handle to rotate the bit on the screw. Moreover, with the screwdriver bit conveniently located at the tip of the pliers, the screwdriver bit is always at the ready, allowing an uninterrupted transition between operations with the pliers and the screwdriver. The bit elements at the ends of the plier jaws cooperatively define a drive bit for a variety of rotary fastener, including a standard, a Phillips, a Torx, a square, an Allen, or other geometrically shaped drive bit.

### CROSS-REFERENCE TO RELATED APPLICATION

This application claims the benefit of priority of U.S. provisional application No. 62/477,058, filed Mar. 27, 2017, the contents of which are herein incorporated by reference.

### BACKGROUND OF THE INVENTION

The present invention relates to hand tools, and more particularly to pliers and screwdrivers.

More than one hand tool such as pliers and screwdrivers are often required for even the smallest of repairs. This can be inconvenient and in some circumstances the user may not have both tools at their disposal.

While there are multi-tools pliers in the art, the screwdriver bits incorporated into these multi-tools are usually folded within the body of the multi-tool along with cutting blades and other tools and gadgets. Accordingly, the screwdriver bits are often difficult to open from the multi-tool body. Additional problems with these multi-tool configurations are their limited ability to develop sufficient torque or apply sufficient pressure to the unfolded screwdriver bit to secure or loosen a screw.

In many circumstances, the bit may return to its folded position with the application of too much pressure. In other circumstances, the pivotal mounting of the bit within the multi-tool limits the applied torque, such that the bit may fail at its mount, or otherwise damage the multi-tool. Additionally, the positioning of the screwdriver bit is usually offset from a natural axis of rotation for the user holding and operating the multi-tool.

As can be seen, there is a need for an improved multi-tool plier that incorporates the functions of pliers with the strength and axial rotation of a conventional screwdriver.

### SUMMARY OF THE INVENTION

In one aspect of the present invention a combination screwdriver and plier hand tool with a standard screwdriver tip is disclosed. The hand tool includes a first plier jaw and a second plier jaw that are pivotally disposed to operate between an open and a closed position. A first bit element is disposed at an end of the first plier jaw, with a second bit element disposed at an end of the second plier jaw. The first bit element and the second bit element are aligned with a rotational path of the first plier jaw and the second plier jaw about a pivot axis of the plier. The first bit element and the second bit element are aligned to form a standard screwdriver blade with the plier hand tool in the closed position.

In some embodiments, lateral sides of the first jaw end and the second jaw end converge towards a longitudinal centerline of the pliers to define the first bit element and second bit element. An interior tip of the first bit element and an interior tip of the second bit element define a fine tip gripping portion for the plier tool.

In some embodiments, a cutting edge is defined in an interior face of at least one of the first plier jaw or the second plier jaw proximal to a pivot of the plier jaw tool. In other embodiments, an arcuate gripping face is defined in an intermediate portion of an interior face of at least one of the first plier jaw or the second plier. A plurality of serrations may be defined in the arcuate gripping face.

In other aspects of the invention, a combination screwdriver and plier hand tool includes a Phillips screwdriver tip. A first plier jaw and a second plier jaw are pivotally disposed about a pivot to operate between an open and a closed position. A first V-shaped bit element is disposed at an end of the first plier jaw and a second V-shaped bit element is disposed at an end of the second plier jaw. The first V-shaped bit element and the second V-shaped bit element define a Phillips screwdriver bit, with the first plier jaw and the second plier jaw operated to the closed position. The first bit element and the second bit element may be defined by a V-shaped protrusion with the apex of the respective V-shaped protrusion defined at a midpoint of the first jaw portion and the second jaw portion. Preferably, the V-shaped protrusion are offset approximately 45 degrees from a rotational path of the first plier jaw and the second plier jaw about the pivot. An interior tip of the first bit element and an interior tip of the second bit element may define a fine tip gripping portion for the plier tool.

In some embodiments, a cutting edge is defined in an interior face of at least one of the first plier jaw or the second plier jaw proximal to the pivot. In other embodiments, an arcuate gripping face is defined in an intermediate portion of an interior face of at least one of the first plier jaw or the second plier. A plurality of serrations defined in the arcuate gripping face.

In yet other aspects of the invention, a combination screwdriver and plier hand tool, includes a first plier jaw and a second plier jaw, pivotally disposed to operate between an open and a closed position. A first bit element is disposed at an end of the first plier jaw and a second bit element disposed at an end of the second plier jaw. The first bit element and the second bit element cooperatively define a geometrically shaped drive bit for cooperative driving engagement with a rotary fastener. The drive bit may be selected from the group consisting of a standard, a Phillips, a Torx, a square, and an Allen tip.

These and other features, aspects and advantages of the present invention will become better understood with reference to the following drawings, description and claims.

### BRIEF DESCRIPTION OF THE DRAWINGS

FIG. 1 is a perspective view of a first representative embodiment of the screwdriver tipped pliers, shown in the closed position.

FIG. 2 is a perspective view of the screwdriver tipped pliers, shown in the open position.

FIG. 3 is a top view of the screwdriver tipped pliers, shown in the closed position.

FIG. 4 is a front view of the screwdriver tipped pliers, illustrating the opening of jaws 10 and 14 about a rotational path.

FIG. 5 is a perspective view of a second representative embodiment of the screwdriver tipped pliers, shown in the closed position.

FIG. 6 is a perspective view of the second embodiment of the screwdriver tipped pliers, shown in the open position.

FIG. 7 is a top view of the second representative embodiment of the screwdriver tipped pliers, shown in the closed position.

FIG. 8 is a front view of the second embodiment of the screwdriver tipped pliers, illustrating the opening of jaws 2 0 and 24.

FIG. 9 is a perspective view of a third alternate embodiment of the screwdriver tipped pliers, shown in the closed position.

FIG. 10 is a perspective view of the third alternate embodiment of the screwdriver tipped pliers, shown in the open position.

FIG. 11 is a perspective view of a fourth alternate embodiment of the screwdriver tipped pliers, shown in the closed position.

FIG. 12 is a perspective view of the fourth alternate embodiment of the screwdriver tipped pliers, shown in the open position.

FIG. 13 is a perspective view of a fifth alternate embodiment of the screwdriver tipped pliers, shown in the closed position.

FIG. 14 is a perspective view of the fifth alternate embodiment of the screwdriver tipped pliers, shown in the open position.

FIG. 15 is a perspective view of a sixth alternate embodiment of the screwdriver tipped pliers, shown in the closed position.

FIG. 16 is a perspective view of the alternate embodiment of the screwdriver tipped pliers, shown in the open position.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a multi-tool plier that includes a screwdriver bit that is integrally formed with a tip of the plier jaws. This configuration provides the user the mechanical advantages of applying a sufficient force to the bit and screw, improved torque, and on-axis operation of the handle to rotate the bit on the screw. Moreover, with the screwdriver bit conveniently located at the tip of the pliers, the screwdriver bit is always at the ready, allowing an uninterrupted transition between operations with the pliers and the screwdriver.

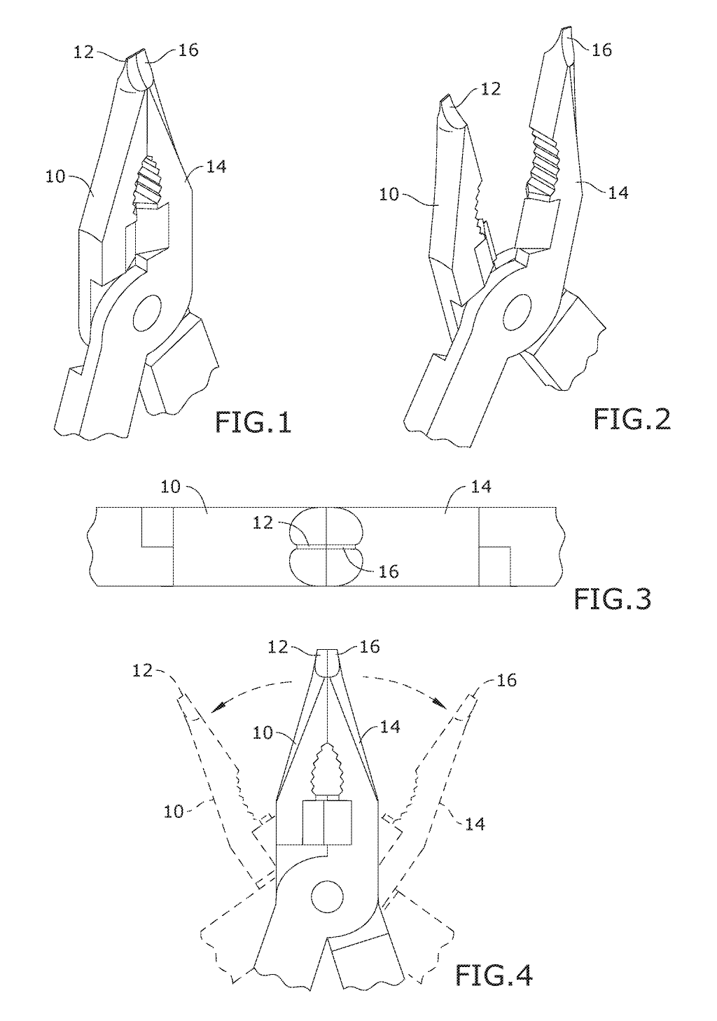

As seen in reference to the drawings of FIGS. 1-4, a first embodiment of the screwdriver tipped pliers include a first 10 and a second 14 pliers jaws that are configured to operate about a pivot between an open and a closed position by operation of handles extending from an opposite end of the plier jaws. A standard screwdriver bit is formed from a first bit element 12 disposed at an end of the first pliers jaw 10 and a second bit element 16 formed at an end of the second pliers jaw 14. The first bit element 12 and the second bit element 16 are aligned across the jaws 10, 14 and aligned with a rotational path of the jaws 10, 14. The lateral sides of the jaw ends 10, 14 converge towards a longitudinal centerline of the pliers. In this embodiment, the first bit element 12 and the second bit element 16 may also be cooperatively engaged for a fine tip gripping portion.

The jaws 10, 14, may also include a cutting element proximal to a pivot point of the jaws 10, 14. Likewise, the jaws 10, 14 may also include a serrated gripping portion along an intermediate portion of the jaws 10, 14. The serrated gripping portion may also include an arcuate form.

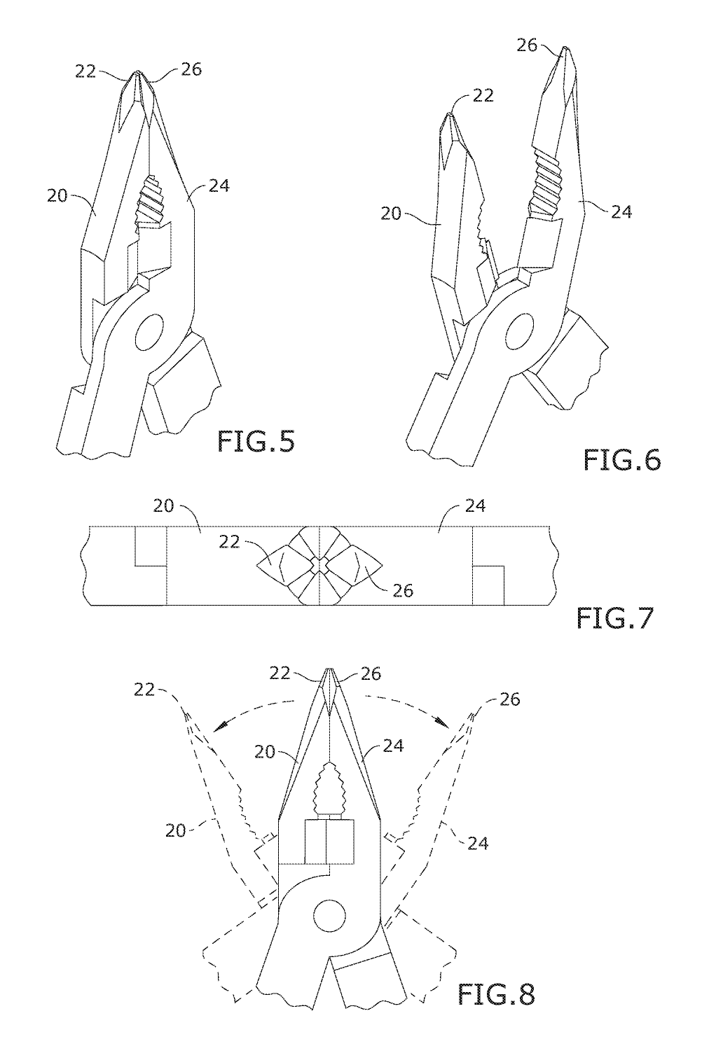

A second embodiment of the screwdriver tipped pliers shown in reference to FIGS. 5-8 may include a Phillips bit disposed at the distal ends of plier jaws 20, 24. The Phillips bit includes a first bit element 22 and a second bit element 26 forming a Phillips bit with the pliers in a closed position. The first bit element 22 and the second bit element 26 are defined by a V-shaped protrusion with the apex of the V defined at a midpoint of the respective first 20 and second 24 jaw portions. In this embodiment, the V-shaped protrusions are offset approximately 45 degrees from the lateral width of the jaws 20, 24, or the rotational axis of the jaws 20, 24. This embodiment is also well suited as a fine tip gripping portion for the pliers.

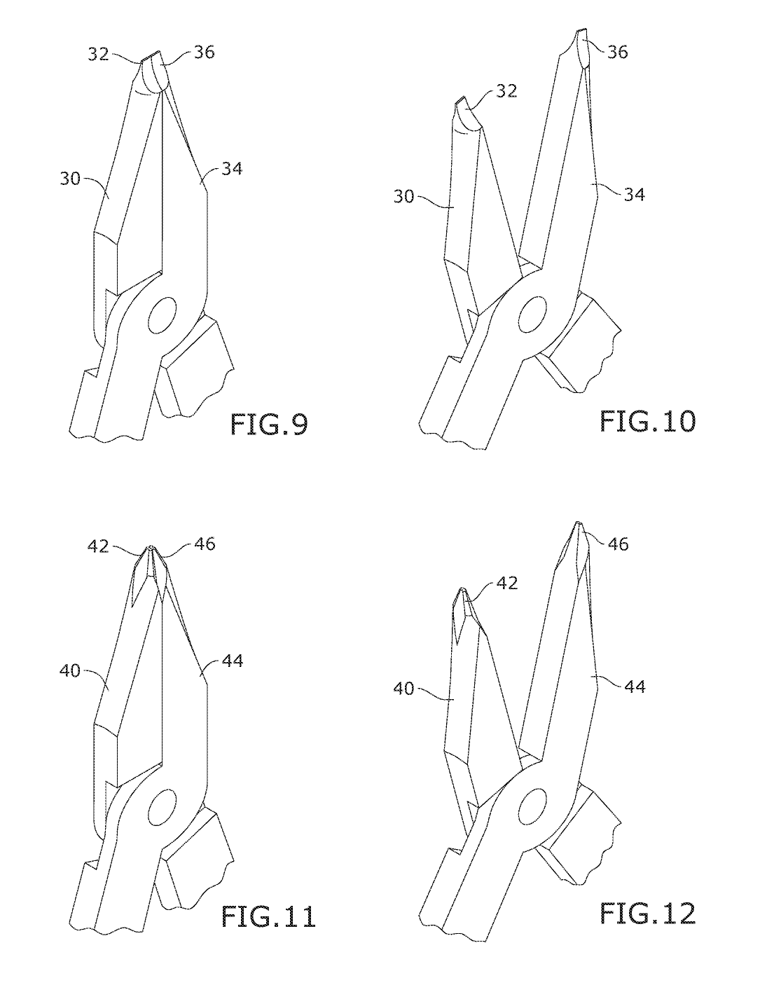

A third embodiment of the screwdriver tipped pliers is illustrated in reference to FIGS. 9 and 10. In this embodiment the jaws 30, 34 are formed without a cutter element or a serrated gripping portion. Tip elements 32, 36 are joined to form a standard head screwdriver bit with the pliers held in the closed position.

A fourth embodiment of the screwdriver tipped pliers is illustrated in reference to FIGS. 11 and 12. In this embodiment the jaws 40, 44 are formed without a cutter element or a serrated gripping portion. As with the second embodiment, V-shaped tip elements 42, 46 are joined to form a Phillips head screwdriver bit with the pliers held in the closed position.

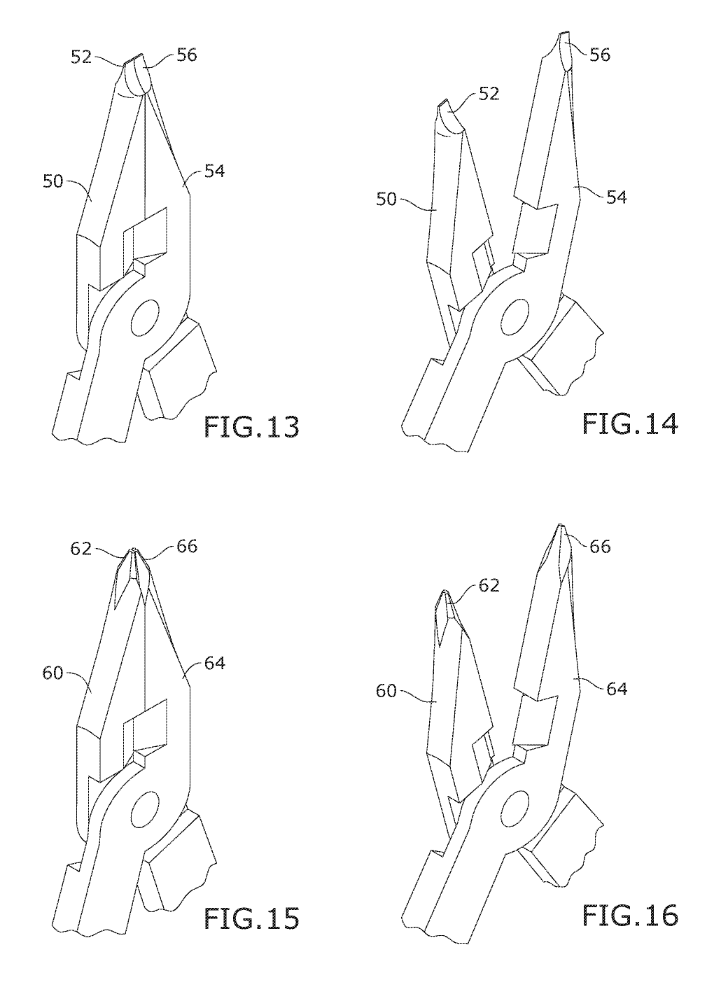

A fifth embodiment of the screwdriver tipped pliers is illustrated in reference to FIGS. 13 and 14. In this embodiment the jaws 50, 54 are formed with a cutter element without an arcuate gripping portion. Tip elements 52, 56 are joined to form a standard head screwdriver bit with the pliers held in the closed position.

A sixth embodiment of the screwdriver tipped pliers is illustrated in reference to FIGS. 15 and 16. In this embodiment the jaws 60, 64 are formed with a cutter element without an arcuate gripping portion. The V-shaped tip elements 62, 66 are joined to form a Phillips head screwdriver bit with the pliers held in the closed position.

As will be appreciated, the respective tip elements may be defined to cooperatively define any of a number of conventional rotary drive bits, such as a Torx, and hex or Allen head, and other geometrically shaped drive bits for securing or releasing a rotary fastener.

It should be understood, of course, that the foregoing relates to exemplary embodiments of the invention and that modifications may be made without departing from the spirit and scope of the invention as set forth in the following claims.

What is claimed is:

1. A combination screwdriver and plier hand tool, comprising:
a first plier jaw and a second plier jaw, pivotally disposed to operate between an open and a closed position;
a first bit element disposed at an end of the first plier jaw;
a second bit element disposed at an end of the second plier jaw, wherein the first bit element and the second bit element are aligned with a rotational path of the first plier jaw and the second plier jaw about a pivot axis of the plier.

2. The combination screwdriver and plier hand tool of claim 1, wherein the first bit element and the second bit element are aligned to form a standard screwdriver blade with the plier hand tool in the closed position.

3. The combination screwdriver and plier hand tool of claim 2, wherein a lateral sides of the first jaw end and the second jaw end converge towards a longitudinal centerline of the pliers defining the first bit element and second bit element.

4. The combination screwdriver and plier hand tool of claim 3, wherein an interior tip of the first bit element and an interior tip of the second bit element define a fine tip gripping portion for the plier tool.

5. The combination screwdriver and plier hand tool of claim 1, wherein a cutting edge is defined in an interior face of at least one of the first plier jaw or the second plier jaw proximal to a pivot of the plier jaw tool.

6. The combination screwdriver and plier hand tool of claim 1, further comprising:
an arcuate gripping face is defined in an intermediate portion of an interior face of at least one of the first plier jaw or the second plier.

7. The combination screwdriver and plier hand tool of claim 6, further comprising:
a plurality of serrations defined in the arcuate gripping face.

8. A combination screwdriver and plier hand tool, comprising:
a first plier jaw and a second plier jaw, pivotally disposed about a pivot to operate between an open and a closed position;
a first V-shaped bit element disposed at an end of the first plier jaw;
a second V-shaped bit element disposed at an end of the second plier jaw, wherein the first V-shaped bit element and the second V-shaped bit element define a Phillips screwdriver bit, with the first plier jaw and the second plier jaw operated to the closed position.

9. The combination screwdriver and plier hand tool of claim 8, wherein the first bit element and the second bit element are defined by a V-shaped protrusion with the apex of the respective V-shaped protrusion defined at a midpoint of the first jaw portion and the second jaw portion.

10. The combination screwdriver and plier hand tool of claim 8, wherein the V-shaped protrusion are offset approximately 45 degrees from a rotational path of the first plier jaw and the second plier jaw about the pivot.

11. The combination screwdriver and plier hand tool of claim 10, wherein an interior tip of the first bit element and an interior tip of the second bit element define a fine tip gripping portion for the plier tool.

12. The combination screwdriver and plier hand tool of claim 8, wherein a cutting edge is defined in an interior face of at least one of the first plier jaw or the second plier jaw proximal to the pivot.

13. The combination screwdriver and plier hand tool of claim 8, further comprising:
an arcuate gripping face defined in an intermediate portion of an interior face of at least one of the first plier jaw or the second plier.

14. The combination screwdriver and plier hand tool of claim 13, further comprising:
a plurality of serrations defined in the arcuate gripping face.

15. A combination screwdriver and plier hand tool, comprising:
a first plier jaw and a second plier jaw, pivotally disposed to operate between an open and a closed position;
a first bit element disposed at an end of the first plier jaw;
a second bit element disposed at an end of the second plier jaw, wherein the first bit element and the second bit element cooperatively define a geometrically shaped drive bit for cooperative driving engagement with a rotary fastener.

16. The combination screwdriver and plier hand tool of claim 15, wherein the drive bit is selected from the group consisting of a standard, a Phillips, a Torx, a square, and an Allen tip.
